(19) United States
(12) Patent Application Publication
(10) Pub. No.: US 2022/0359857 A1
(43) Pub. Date: Nov. 10, 2022

(54) PRELITHIATED ANODE, LITHIUM-ION BATTERIES CONTAINING A PRELITHIATED ANODE AND METHOD OF PRODUCING SAME

(71) Applicant: Global Graphene Group, Inc., Dayton, OH (US)

(72) Inventor: Bor Z. Jang, Centerville, OH (US)

(21) Appl. No.: 17/244,441

(22) Filed: Apr. 29, 2021

(51) Int. Cl. H01M 4/04; H01M 10/0525; H01M 4/62; H01M 4/52; H01M 4/38; H01M 4/13; H01M 4/134; H01M 4/139; H01M 4/1395

(52) U.S. Cl. CPC H01M 4/0459; H01M 10/0525; H01M 4/628; H01M 4/625; H01M 4/523; H01M 4/386; H01M 4/13; H01M 4/134; H01M 4/139; H01M 4/1395; H01M 4/582

(57) ABSTRACT

The disclosure provides a method of prelithiating an anode for a lithium-ion cell, the method comprising: (a) providing a pre-fabricated anode comprising an anode active material; (b) prelithiating the pre-fabricated anode by exposing the anode to a lithium source and an electrolyte solution, comprising a lithium salt dissolved in a liquid solvent, to enable lithium ions to intercalate into the anode active material until a level of lithium interaction from 5% to 100% of the maximum lithium storage capacity is achieved to form a prelithiated anode; and (c) introducing a protective polymer onto the prelithiated anode to prevent exposure of the prelithiated anode active material to the open air or into the anode to bond the prelithiated anode active material or to improve a structural integrity of the prelithiated anode, wherein the protective polymer has a lithium-ion conductivity from 10⁻⁸ S/cm to 5×10⁻² S/cm at room temperature.

### GOVERNMENT RIGHTS

This disclosure was made with government support under the US Air Force SBIR Program. The US government has certain rights in the disclosure.

### FIELD

The present disclosure relates generally to the field of lithium-ion batteries and, in particular, to a prelithiated anode (negative electrode) for a lithium-ion battery and a method of producing prelithiated anode active material layers.

### BACKGROUND

A unit cell or building block of a lithium-ion battery is typically composed of an anode current collector, an anode or negative electrode layer (also known as an anode active material layer typically containing an anode active material responsible for storing lithium therein, a conductive additive, and a resin binder), an electrolyte and porous separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte; or the separator itself contains a solid-state electrolyte.

The binder in the anode layer is used to bond the anode active material (e.g., graphite or Si particles) and a conductive filler (e.g., carbon black or carbon nanotube) together to form an anode layer of structural integrity, and to bond the anode layer to an anode current collector, which acts to collect electrons from the anode active material when the battery is discharged. In other words, in the negative electrode (anode) side of the battery, there are typically four different materials involved: an anode active material, a conductive additive, a resin binder (e.g., polyvinylidine fluoride, PVDF, or styrene-butadiene rubber, SBR), and an anode current collector (typically a sheet of Cu foil). Typically, the former three materials form a separate, discrete anode active material layer that is bonded to the latter one (Cu foil). In some cases, a Cu foil can be deposited with two anode active material layers on the two primary surfaces of the Cu foil.

The most commonly used anode active materials for lithium-ion batteries are natural graphite and synthetic graphite (or artificial graphite) that can be intercalated with lithium and the resulting graphite intercalation compound may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the purpose of the charge transfer between an anode and a cathode. As the SEI is formed, the lithium ions become part of the inert SEI layer and become irreversible, i.e. these positive ions can no longer be shuttled back and forth between the anode and the cathode during subsequent charges/discharges. Therefore, it is desirable to use a minimum amount of lithium for the formation of an effective SEI layer. In addition to SEI formation, the irreversible capacity loss Qᵢᵣ can also be attributed to graphite exfoliation caused by electrolyte/solvent co-intercalation and other side reactions.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.

To overcome the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film must have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g. up to a volume expansion of 380%) during the battery charge step, the protective coating is easily broken due to the mechanical weakness and/o brittleness of the protective coating materials. There has been no high-strength and high-toughness material available that is itself also lithium ion conductive.

The prior art protective materials all fall short of these requirements. Hence, it is not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.

Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g. those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, polymeric carbon, amorphous carbon, or pre-graphitic carbon may have too many lithium-trapping sites that irreversibly capture lithium during the first few cycles, resulting in excessive irreversibility.

Prelithiation of silicon is an effective way to alleviate the issues associated with the large volume expansion and rapid capacity decay for silicon anodes. Prelithiation involves intercalating lithium ions into the silicon prior to subjecting the electrode to a charging cycle. Known methods of prelithiation can involve dipping a web of electrochemically active material, prior to forming an electrode therefrom, in an organic salt while running a current through the web. One example is based on one of our earlier patents: Aruna Zhamu and Bor Z. Jang, “Surface-Stabilized and Prelithiated Anode Active Materials for Lithium Batteries and Production Method,” U.S. Pat. No. 10,256,459 (Apr. 9, 2019). Other methods of prelithiation involve directly contacting electrochemically active material with lithium metal, or depositing lithium metal directly onto the active material, for example via a vapor deposition or sputtering process.

S. J. Deng, et al. (US Publication No. 20210104740, Published on Apr. 8, 2021) disclosed a method of prelithiating a silicon-containing electrode in the form of an electrode roll. The method comprises (a) electrically connecting the silicon-containing electrode to a negative terminal of an electrical power source; (b) immersing the silicon-containing electrode in a lithium salt solution; wherein a lithium source is immersed in the lithium salt solution such that it does not directly contact the silicon-containing electrode and the lithium source is electrically connected to a positive terminal of the electrical power source; and (c) applying a current from the electrical power source to the silicon-containing electrode for a duration until a desired level of lithium intercalation of the silicon-containing electrode is achieved.

This disclosure suggests that the desired level of lithium intercalation (or degree of prelithiation) is from 10% to 40%, which is not sufficient for the lithiated anode material (i.e., Si particles) to serve as a lithium source in the lithium-ion cells wherein the cathode is lithium-free when the cell is made. Examples of lithium-free cathode active materials are TiS₂, TaS₂, MoS₂, NbSe₃, MnO₂, CoO₂, an iron oxide, a vanadium oxide, CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and most of the organic and organometallic cathode materials. Many of these initially lithium-free cathode active materials are capable of storing more lithium than existing lithium transition metal oxide-based cathode materials. However, Si particles that are fully prelithiated can undergo a 380% volume expansion, thereby damaging or disintegrating the pre-fabricated anode electrode. A strong need exists for a method capable of prelithiating a pre-fabricated anode to its full capacity without damaging the electrode.

There is an urgent and continuing need for a new anode active material layer that enables a lithium-ion battery to exhibit a high cycle life, high reversible capacity, low irreversible capacity, and compatibility with commonly used electrolytes. There is also a need for a method of readily or easily producing such an anode in large quantities.

Thus, it is a specific object of the present disclosure to meet these needs and address the issues associated the rapid capacity decay of a lithium battery containing a high-capacity anode active material.

### SUMMARY

The present disclosure provides a method of prelithiating an anode for a lithium-ion cell, the method comprising: (a) providing a pre-fabricated anode comprising an anode active material having a maximum lithium storage capacity; (b) prelithiating the pre-fabricated anode by exposing the anode to a lithium source and an electrolyte solution, comprising a lithium salt dissolved in a liquid solvent, to enable lithium ions to intercalate into the anode active material until a level of lithium interaction, herein also referred to as a degree of prelithiation, from 5% to 100% of the maximum lithium storage capacity is achieved to form a prelithiated anode comprising prelithiated an anode active material; and (c) introducing a protective polymer onto the prelithiated anode to prevent exposure of the prelithiated anode active material to the open air or into the anode to bond the prelithiated anode active material (or to improve the structural integrity of the prelithiated anode), wherein the protective polymer has a lithium-ion conductivity from 10⁻⁸ S/cm to 5×10⁻² S/cm at room temperature.

In certain embodiments, the anode comprises multiple particles of an anode active material, an optional conductive additive, and a first binder that holds the multiple anode material particles and the conductive additive together to form an anode layer that is optionally supported on a primary surface of a current collector. The two primary surfaces of a current collector (e.g., Cu foil) may be each coated with such an anode active material layer, each comprising multiple anode active material particles and an optional conductive additive (e.g., carbon black, carbon nanotubes or CNTs, etc.) that are bonded by a first binder resin.

In some embodiments, the anode comprises multiple particles of an anode active material distributed within a carbon phase. In some embodiments, the anode comprises a film comprising the anode active material and a carbon phase that holds the film together.

The anode active material may be selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium niobate, lithium transition metal oxide; (f) carbon or graphite particles; and (g) combinations thereof. Preferably, the anode active material is selected from silicon (Si), germanium (Ge), phosphorus (P), tin (Sn), SiOₓ (0<x<2.0), SnO₂, or a combination thereof.

In the disclosed method, step (b) may comprise (i) depositing or spraying a film or particles of lithium or a lithium alloy, as a lithium source, onto surfaces of the anode active material and (ii) bringing the electrolyte solution to come in ionic communication or physical contact with both the anode active material and the lithium source. In this procedure, the anode active material is in physical contact with a lithium source (lithium or a lithium-rich alloy preferably having >60% by weight Li) and lithiation of the anode active material occurs as soon as a lithium salt solution (liquid electrolyte) comes in contact with both the anode active material and the lithium source.

In this procedure, the lithium film depositing may be conducted by using vapor deposition, sputtering, electron beam deposition, ion implementation, or a combination thereof. This procedure is preferably conducted in a roll-to-roll manner. This may be preferably conducted by providing a pre-fabricated anode which is made by feeding a Cu foil from a roll into a coating zone and coating an anode active material layer or two layers onto one or both primary surfaces of the Cu foil using the well-known slurry coating and drying process. In some embodiments, the pre-fabricated anode, after drying, is deposited with lithium or lithium-rich alloy (powder or film) onto surfaces of the anode active material. The anode is then sprayed with an electrolyte solution (containing a lithium salt dissolved in a liquid solvent) to activate the pre-lithiation procedure, resulting in volume expansion of the anode active material (e.g., Si can get expanded by up to approximately 380% if fully prelithiated). The anode active material in the prelithiated or volume-expanded state is then covered with or protected by a layer of a protective polymer. This protective polymer may be applied to the surfaces of the anode active material through polymer solution spraying, dipping, coating, casting, etc., followed by solvent removal.

In certain embodiments, step (b) of the disclosed method comprises (i) immersing the pre-fabricated anode and the lithium source, comprising lithium, in the electrolyte solution and (ii) applying a current from an electrical power source between the pre-fabricated anode and the lithium source for a length of time sufficient to achieve the desired level of lithium intercalation. The method is preferably conducted in a roll-to-roll manner. The current from the electric power source preferably results in a current density in the anode of from about 0.05 mA/cm² to about 5 mA/cm².

Preferably, the anode is prelithiated to a level of lithium interaction from 40% to 100% of the maximum lithium storage capacity, inducing a volume expansion of the anode active material to an extent of from 10% to 380%, followed by introducing the protective polymer to bond the expanded anode active material.

It may be noted that the pre-fabricated anode typically contains multiple anode active particles, along with a conductive additive, being bonded by a first binder resin. Alternatively, the anode comprises multiple particles of an anode active material distributed within a carbon phase or the anode comprises a film comprising the anode active material and a carbon phase that holds the film together. In all these situations, the first binder resin (if a conventional binder resin) or the supporting carbon phase is incapable of holding the anode active material in place when the volume expansion of the anode active material exceeds 10%, 20%, 30%, etc. (up to 380%). Consequently, the anode active material can be either detached from the supporting binder or carbon phase or fragmented into pieces. This could not only make it challenging to handle for subsequent battery cell assembling process but also interrupt the electron- or ion-conducting pathways. This latter phenomenon typically results in rapid capacity decay of the resultant battery. The protective polymer herein introduced can serve as a second binder resin to help hold the expanded anode active material together.

In some embodiments, the anode comprises multiple particles of an anode active material, a conductive additive, and a first binder resin that holds the multiple anode material particles and the conductive additive together to form an anode layer and wherein the protective polymer assists to further hold the expanded particles of the anode active material and the conductive additive together to form an anode of sufficient structural integrity to enable subsequent handling of the anode.

The lithium salt in the disclosed method may be selected from lithium hydroxide, LiOH, lithium carbonate, Li₂CO₃, lithium halide, LiX (X═F, Cl, B, or I), lithium methoxide, lithium azide, lithium acetate, lithium acetylacetonate, lithium amide, lithium acetylides, R—Li (R=alkyl and aryl), R₃DLi derivatives, where D=Si, Ge, Sn and R=alkyl or aryl, lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium trifluoromethanesulfonimide (LiTFSI), lithium oxalyldifluoroborate (LiODFB), LiPF₃(CF₂CF₃)₃(LiFAP), LiBF₃(CF₂CF₃)₃(LiFAB), LiN(C₂F₅SO₂)₂, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), a lithium salt having a cyclic alkyl group, an ionic liquid-based lithium salt, or a combination thereof.

In certain embodiments, the protective polymer comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

In certain embodiments, the protective polymer and/or the first binder resin comprises a high-elasticity polymer having a recoverable elastic strain from 5% to 1,000% when measured under tension.

The high-elasticity polymer preferably comprises an elastomer selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, vinyl acetate-acrylic copolymer rubber, silicone rubber, fluorosilicone rubber, perfluoroelastomers, polyether block amides, chlorosulfonated polyethylene, ethylene-vinyl acetate, polysulphide rubber, polypropylene oxide rubber, polypropylene oxide-allyl glycidyl ether copolymer rubber, thermoplastic elastomer, protein resilin, protein elastin, ethylene oxide-epichlorohydrin copolymer, polyurethane, urethane-urea copolymer, urethane-acrylic copolymer, or a combination thereof.

In some embodiments, the high-elasticity polymer comprises a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

The disclosure also provides a prelithiated anode for a lithium-ion battery, the anode comprising (A) an anode active material having a maximum lithium storage capacity, wherein the anode active material is prelithiated to a level of lithium interaction (or degree of prelithiation) from 5% to 100% of the maximum lithium storage capacity; and (B) a protective polymer that prevents exposure of the prelithiated anode active material to the open air or bonds the prelithiated anode active material for improving the structural integrity of the prelithiated anode, wherein the protective polymer has a lithium-ion conductivity from 10⁻⁸ S/cm to 5×10⁻² S/cm at room temperature.

In the prelithiated anode, the protective polymer preferably contains a lithium salt dispersed in the polymer and the lithium salt is selected from the group consisting of lithium methoxide, lithium azide, lithium halides, lithium acetate, lithium acetylacetonate, lithium amides, lithium acetylides, R—Li (R=alkyl and aryl), R₃DLi derivatives, where D=Si, Ge, Sn and R=alkyl or aryl, lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium trifluoromethanesulfonimide (LiTFSI), lithium oxalyldifluoroborate (LiODFB), LiPF₃(CF₂CF₃)₃(LiFAP), LiBF₃(CF₂CF₃)₃(LiFAB), LiN(C₂F₅SO₂)₂, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), a lithium salt having a cyclic alkyl group, an ionic liquid-based lithium salt, and combinations thereof.

In some embodiments, the anode comprises multiple particles of an anode active material, an optional conductive additive, and a first binder that holds the multiple anode material particles and the conductive additive together to form an anode layer that is optionally supported on a primary surface of a current collector.

Alternatively, the anode comprises multiple particles of an anode active material distributed within a carbon phase. Further alternatively, the anode comprises a film comprising the anode active material and a carbon phase that holds the film together.

The anode active material may be selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium niobate, lithium transition metal oxide; (f) carbon or graphite particles; and (g) combinations thereof. Preferably, the anode active material is selected from silicon (Si), germanium (Ge), phosphorus (P), tin (Sn), SiOₓ (0<x<2.0), SnO₂, or a combination thereof.

In the prelithiated anode, the conductive additive may be selected from carbon black, acetylene black, graphene, carbon particles, graphite flakes, carbon nanotubes, carbon fibers, needle coke, amorphous carbon, conducting polymer, metal, conductive composite, or a combination thereof. The graphene may be selected from pristine graphene, graphene fluoride, graphene chloride, graphene bromide, graphene iodide, nitrogenated graphene, hydrogenated graphene, doped graphene, chemically functionalized graphene, a combination thereof, or a combination thereof with graphene oxide or reduced graphene oxide.

In some embodiments, the anode active material is intercalated to a degree of prelithiation from 30% to 100% of the maximum lithium storage capacity, preferably >40%, further preferably >50%.

The protective polymer may comprise a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

In some desired embodiments, in the prelithiated anode, the protective polymer and/or the first binder resin comprises a high-elasticity polymer having a recoverable elastic strain from 5% to 1,000% when measured under tension. The high-elasticity polymer preferably comprises an elastomer selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, vinyl acetate-acrylic copolymer rubber, silicone rubber, fluorosilicone rubber, perfluoroelastomers, polyether block amides, chlorosulfonated polyethylene, ethylene-vinyl acetate, polysulphide rubber, polypropylene oxide rubber, polypropylene oxide-allyl glycidyl ether copolymer rubber, thermoplastic elastomer, protein resilin, protein elastin, ethylene oxide-epichlorohydrin copolymer, polyurethane, urethane-urea copolymer, urethane-acrylic copolymer, or a combination thereof.

The high-elasticity polymer may comprise a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

The disclosure also provides a lithium-ion cell comprising the disclosed prelithiated anode, a cathode comprising a cathode active material, an ion-permeable separator disposed between the prelithiated anode and the cathode.

The cathode active material may be selected from an inorganic material, an organic material, a polymeric material, or a combination thereof.

The inorganic material may be selected from a metal oxide, metal phosphate, metal silicide, metal selenide, transition metal sulfide, sulfur, lithium polysulfide, selenium, lithium selenide, or a combination thereof.

The inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, or V, Mb is selected from Fe, Mn, Co, Ni, V, Ti, Al, B, Sn, or Bi; and x+y≤1. Examples of the lithium transition metal oxide- or lithium mixed transition metal oxide-based positive active materials include: Li (M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂), Li(Co_{X}M_{1-X})O₂, where M is a metal, (e.g. Li(Co_{X}Ni_{1-X})O₂ and Li(Co_{X}Fe_{1-X})O₂), Li_{1-W}(Mn_{X}Ni_{Y}Co_{Z})O₂, (e.g. Li(Co_{X}Mn_{Y}Ni_{(1-X-y)})O₂, Li(Mn_{1/3}Ni_{1/3}Co_{1/3})O₂, Li(Mn_{1/3}Ni_{1/3}Co_{1/3-X}Mg_{X})O₂, Li(Mn_{0.4}Ni_{0.4}Co_{0.2})O₂, Li(Mn_{0.1}Ni_{0.1}Co_{0.8})O₂), Li_{1-W}(Mn_{X}Ni_{X}Co_{1-2X})O₂, Li_{1-W}Mn_{X}Ni_{Y}CoAl_{W})O₂, Li_{1-W}(Ni_{X}Co_{Y}Al_{Z})O₂, where W=0-1, (e.g., Li(Ni_{0.8}Co_{0.15}Al_{0.05})O₂), Li_{1-W}(Ni_{X}Co_{Y}M_{Z})O₂, where M is a metal, Li_{1-W}(Ni_{X}Mn_{Y}M_{Z})O₂, where M is a metal, Li(Ni_{X}Mn_{Y}Cr_{2-X})O₄, LiM′M″₂O₄, where M′ and M″ are different metals (e.g., LiMn_{2-Y-Z}Ni_{Y}O₄, LiMn_{2-Y-Z}Ni_{Y}Li_{Z}O₄, LiMn_{1.5}Ni_{0.5}O₄, LiNiCuO₄, LiMn_{1-X}Al_{X}O₄, LiNi_{0.5}Ti_{0.5}O₄, Li_{1.05}Al_{0.1}Mn_{1.85}O_{4-z}F_{z}, Li₂MnO₃) Li_{X}V_{Y}O_{Z}, e.g. LiV₃O₈, LiV₂O₅, and LiV₆O₁₃. This list includes the well-known lithium nickel cobalt manganese oxides (NCM) and lithium nickel cobalt manganese aluminum oxides (NCM), among others.

The metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In certain desired embodiments, the inorganic material is selected from a lithium-free cathode material. Such an initially lithium-free cathode may contain a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In these cases, it is particularly desirable to have the anode active material prelithiated to a high level, preferably no less than 50%. In some preferred embodiments, prelithiated anode comprises Si that is prelithiated to approximately 60-100% and the cathode comprises a cathode active material that is initially lithium-free.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide or metal phosphate may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The organic material or polymeric material may be selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer is selected from Poly[methanetetryl-tetra(thiomethylene)](PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

The organic material may contain a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

### BRIEF DESCRIPTION OF THE DRAWINGS

FIG. 1(A) Flow chart briefly summarizing the method of prelithiating and protecting an anode.

FIG. 1(B) Schematic of a roll-to-roll process for prelithiating and then protecting an anode active material layer with a protective polymer, according to some preferred embodiments of the present disclosure;

FIG. 1(C) Schematic of an electrochemical apparatus or reactor for prelithiating and protecting an anode active material layer, according to a preferred embodiment of the present disclosure.

FIG. 2(A) Schematic illustrating the notion that expansion of Si particles, upon lithium intercalation during charging of a prior art lithium-ion battery, can lead to pulverization of Si particles, interruption of the conductive paths formed by the conductive additive, and loss of contact with the current collector;

FIG. 2(B) illustrates the issues associated with the prior art anode active material; for instance, a non-lithiated Si particle encapsulated by a protective shell (e.g. carbon shell) in a core-shell structure inevitably leads to breakage of the shell and that a pre-lithiated Si particle encapsulated with a protective layer leads to poor contact between the contracted Si particle and the rigid protective shell during battery discharge.

FIG. 3 illustrates the prelithiated anode with polymer protection, both in the discharged and charged state, as well as a depiction of how the anode might look before and after prelithiation.

### DETAILED DESCRIPTION

A lithium-ion battery cell is typically composed of an anode current collector (e.g., Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, Si, or SiOₓ, where 0<x<2), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

The anode current collector may be coated with one anode active material layer on one primary surface or two anode active material layers on the two primary surfaces of a current collector. The term “anode” or “negative electrode” refers to the laminate composed of a current collector and one or two anode active material layers bonded thereto. The term anode can refer to an anode active material layer, particularly if there is no anode current collector.

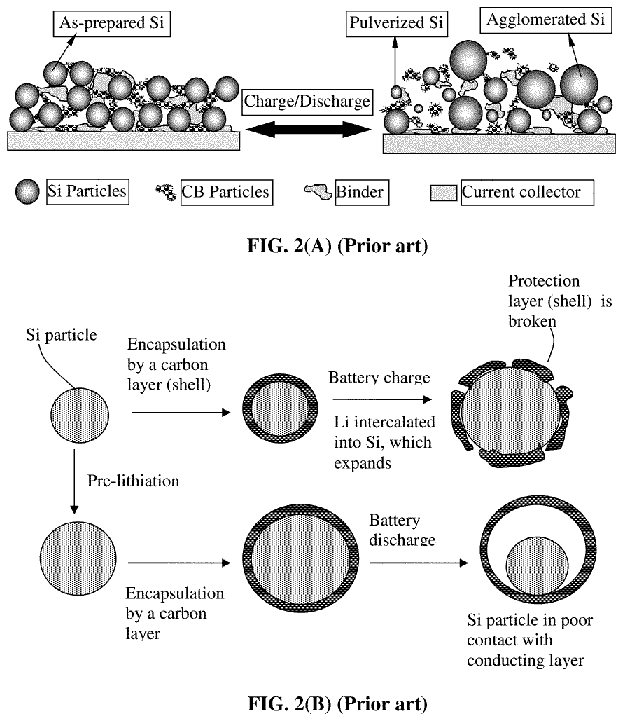

In order to obtain a higher energy density cell, the anode can be designed to contain higher-capacity anode active materials having a composition formula of LiₐA (A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). Each and every one of these anode active materials has a maximum lithium ion or charge storage capacity (e.g., 1,623 mAh/g for Ge). However, as discussed in the Background section, there are several problems associated with the implementation of these high-capacity anode active materials:
1) As schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.
2) The approach of using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles, has failed to overcome the capacity decay problem. Presumably, the protective matrix provides a constraining effect for particle expansion or shrinkage, and prevents the electrolyte from contacting and reacting with the electrode active material. Unfortunately, when an active material particle, such as Si particle, expands (e.g. up to a volume expansion of 380%) during the battery charge step, the protective coating is easily broken due to the mechanical weakness and/or brittleness of the protective coating materials. There has been no high-strength and high-toughness material available that is itself also lithium ion conductive.
3) The approach of using a core-shell structure (e.g. Si nano particle encapsulated in a carbon or SiO₂ shell) also has not solved the capacity decay issue. As illustrated in upper portion of FIG. 2(B), a non-lithiated Si particle can be encapsulated by a carbon shell to form a core-shell structure (Si core and carbon or SiO₂ shell in this example). As the lithium-ion battery is charged, the anode active material (carbon- or SiO₂-encapsulated Si particle) is intercalated with lithium ions and, hence, the Si particle expands. Due to the brittleness of the encapsulating shell (carbon), the shell is broken into segments, exposing the underlying Si to electrolyte and subjecting the Si to undesirable reactions with electrolyte during repeated charges/discharges of the battery. These reactions continue to consume the electrolyte and reduce the cell's ability to store lithium ions.
4) Referring to the lower portion of FIG. 2(B), wherein the Si particle has been pre-lithiated with lithium ions; i.e. has been pre-expanded in volume. When a layer of carbon (as an example of a protective material) is encapsulated around the pre-lithiated Si particle, another core-shell structure is formed. However, when the battery is discharged and lithium ions are released (de-intercalated) from the Si particle, the Si particle contracts, leaving behind a large gap between the protective shell and the Si particle. Such a configuration is not conducive to lithium intercalation of the Si particle during the subsequent battery charge cycle due to the gap and the poor contact of Si particle with the protective shell (through which lithium ions can diffuse). This would significantly curtail the lithium storage capacity of the Si particle particularly under high charge rate conditions.

In other words, there are several conflicting factors that must be considered concurrently when it comes to the design and selection of an anode active material in terms of material type, shape, size, porosity, electrode layer thickness, anode binder, and anode material prelithiation. Conventional strategies for prelithiating the anode particles or the anode electrode have also fallen short of addressing the rapid cycle decay issues. Thus far, there has been no effective solution offered by any prior art teaching to these conflicting problems. We have solved these challenging issues that have troubled battery designers and electrochemists alike for more than 30 years by developing the protected and prelithiated anode electrodes.

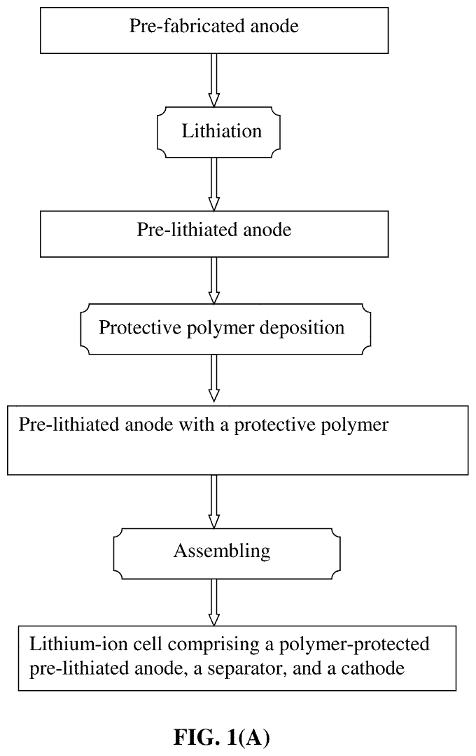

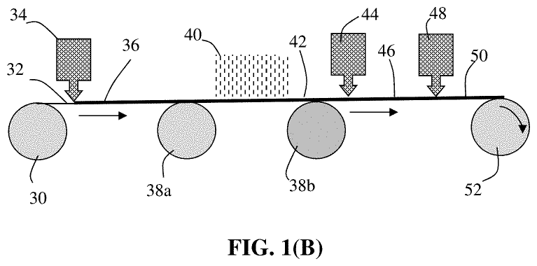

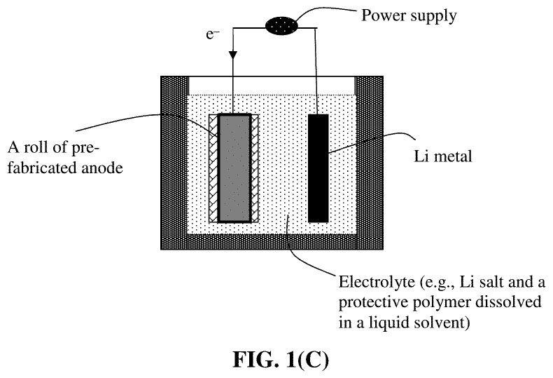

As illustrated in FIG. 1(A), the present disclosure provides a method of prelithiating an anode for a lithium-ion cell, the method comprising: (a) providing a pre-fabricated anode comprising an anode active material having a maximum lithium storage capacity; (b) prelithiating the pre-fabricated anode by exposing the anode to a lithium source and an electrolyte solution, comprising a lithium salt dissolved in a liquid solvent, to enable lithium ions to intercalate into the anode active material until a level of lithium interaction, herein also referred to as a degree of prelithiation, from 5% to 100% of the maximum lithium storage capacity is achieved to form a prelithiated anode comprising prelithiated an anode active material; and (c) introducing a protective polymer onto the prelithiated anode to prevent exposure of the prelithiated anode active material to the open air or into the anode to bond the prelithiated anode active material or to improve a structural integrity of the prelithiated anode, wherein the protective polymer has a lithium-ion conductivity from 10⁻⁸ S/cm to 5×10⁻² S/cm at room temperature. The disclosure also provides a prelithiated anode or anode active material layer that meets the above conditions or made by using this method.

In certain embodiments, the anode comprises multiple particles of an anode active material, an optional conductive additive, and a first binder that holds the multiple anode material particles and the conductive additive together to form an anode layer that is optionally supported on a primary surface of a current collector. The two primary surfaces of a current collector (e.g., Cu foil) may be each coated with such an anode active material layer, each comprising multiple anode active material particles and an optional conductive additive (e.g., carbon black, carbon nanotubes or CNTs, etc.) that are bonded by a first binder resin.

In some alternative embodiments, the anode comprises multiple particles of an anode active material distributed within a carbon phase. In some embodiments, the anode comprises a film comprising the anode active material and a carbon phase that holds the film together.

The anode active material may be selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium niobate, lithium transition metal oxide; (f) carbon or graphite particles; and (g) combinations thereof. Preferably, the anode active material is selected from silicon (Si), germanium (Ge), phosphorus (P), tin (Sn), SiOₓ (0<x<2.0), SnO₂, or a combination thereof.

In some preferred embodiments, as schematically illustrated in FIG. 1(B), the method is preferably conducted in a roll-to-roll manner. For instance, the desired process may begin with unwinding a Cu foil 32 from a roll 30, and operating a dispensing/coating device to coat a slurry (comprising multiple particles of an anode active material, an optional conductive additive, and a first binder resin) onto one or both primary surfaces of the Cu foil. This is preferably followed by drying to obtain a pre-fabricated anode active material layer 36 supported by a current collector (the Cu foil). This can be accomplished by using the conventional slurry coating and drying process, or any well-known process of electrode preparation. The first binder resin holds the multiple anode material particles and the conductive additive together to form an anode layer.

This layer 36 is moved, continuously or intermittently, toward the right-hand side, into a lithium metal deposition zone where lithium metal is emitted and deposited onto a surface of the pre-fabricated anode layer using a deposition device 40, such as a sputtering system, a vapor deposition device, or an electron beam deposition device. The deposited lithium film now comes in physical contact with the anode active material (e.g., Si particles or a Si phase dispersed in a carbon phase), forming a lithium film-covered or lithium film-deposited anode layer 42. The next step entails bringing an electrolyte solution to come in contact with deposited lithium metal and the anode active material; e.g., by using a solution dispenser 44 to deposit the electrolyte solution onto the lithium-carrying layer 42 to activate the prelithiation procedure to obtain a prelithiated anode active material layer 46. With the presence of a liquid electrolyte, the lithium film and the anode active material are made into a short-circuiting situation, enabling lithium to intercalate into the anode active material at a very high rate. A polymer solution spraying, depositing, or coating device 48 is then used to deposit a protective polymer onto the surface of the anode active material to produce the polymer-protected, prelithiated anode layer 50 supported on the Cu foil. This anode layer is then collected on a winding roller 52. Two optional rollers 38a, 38b are used for supporting the movement of the anode layer.

It may be noted that the electrolyte solution deposition procedure (e.g., using a dispensing device 44) may be integrated with the protective polymer deposition procedure (e.g., involving 48) into one step if the protective polymer and the lithium salt are dissolved into the same liquid solvent to form a multi-component solution. The device 44 delivers not only the lithium salt solution, but also the polymer to the anode active material. The polymer gets to precipitate out as a solid when the liquid solvent is removed partially or totally.

Alternatively, the lithium-carrying layer 42 may be moved to immerse into an electrolyte solution comprising a lithium salt and a protective polymer dissolved in a liquid solvent. Intercalation of lithium into the anode active material occurs in the electrolyte solution. When the prelithiated anode layer emerges from the solution, a thin polymer film will get precipitated out and gets to deposit onto the anode active material as a protective film and/or as a second binder resin to help hold the anode active particles together.

In some embodiments, an amount or level of prelithiation of an electrode may be defined as the percentage of the anode active material (e.g. silicon) in the pre-fabricated anode electrode that is alloyed with lithium during a prelithiation process. In some embodiments (e.g., for the anode to be paired up with a cathode containing a lithiated or lithium-containing cathode active material, such as LiCoO₂, LiMn₂O₄, NCM, NCA, and LFP), the methods described herein may be able to achieve prelithiation levels of greater than 5%, greater than 10%, greater than 15%, greater than 20%, greater than 25%, or greater. In some embodiments the methods described herein may be able to achieve prelithiation levels of about 4%, about 8%, about 12%, about 15%, about 20%, about 25%, about 30%, about 35%, about 40%, or any range of values therebetween, for example such as about 10% to about 30%. In some embodiments (e.g., for an anode to work with a non-lithiated cathode active material, such as CoF₃, MnF₃, FeF₃, VF₃, VOF₃, TiF₃, BiF₃, NiF₂, FeF₂, CuF₂, CuF, SnF₂, AgF, CuCl₂, FeCl₃, or MoS₂), the desired level of prelithiation in a silicon-containing electrode may be any percentage from 40% to 100%, preferably greater than 60%, further preferably greater than 80%.

In summary, in the disclosed method, step (b) may comprise (i) depositing or spraying a film or particles of lithium or a lithium alloy (as a lithium source) onto surfaces of the anode active material and (ii) bringing the electrolyte solution to come in ionic communication or physical contact with both the anode active material and the lithium source. In this procedure, the anode active material is in physical contact with a lithium source (lithium or a lithium-rich alloy preferably having >60% by weight Li) and lithiation of the anode active material occurs as soon as a lithium salt solution (liquid electrolyte) comes in contact with both the anode active material and the lithium source.

In this procedure, the lithium film depositing may be conducted by using vapor deposition, sputtering, electron beam deposition, ion implementation, laser ablation, or a combination thereof. This procedure is preferably conducted in a roll-to-roll manner. This may be preferably conducted by providing a pre-fabricated anode which is made by feeding a Cu foil from a roll into a coating zone and coating an anode active material layer or two layers onto one or both primary surfaces of the Cu foil using the well-known slurry coating and drying process. In some embodiments, the pre-fabricated anode, after drying, is deposited with lithium or lithium-rich alloy (powder or film) onto surfaces of the anode active material. The anode is then sprayed with an electrolyte solution (containing a lithium salt dissolved in a liquid solvent) to activate the pre-lithiation procedure, resulting in volume expansion of the anode active material (e.g., Si can get expanded by up to approximately 380% if fully prelithiated). The anode active material in the prelithiated or volume-expanded state is then covered with or protected by a layer of a protective polymer. This protective polymer may be applied to the surfaces of the anode active material through polymer solution spraying, dipping, coating, casting, etc., followed by solvent removal.

A thin lithium layer can be deposited on the surface of an anode material layer substrate using a standard thin film process, such as thermal evaporation, electron beam evaporation, sputtering, and laser ablation. A vacuum may be used during the deposition process to avoid reactivity between the atomic lithium and molecules of lithium-reactive substances such as water, oxygen, and nitrogen. A vacuum of greater than 1 milli-Torr is desirable. When electron beam deposition is used a vacuum of 10⁻⁴ Torr is desired and a vacuum of 10⁻⁶ Torr is preferred to avoid interaction between the electron beam and any residual air molecules.

The evaporative deposition techniques involve the heating of a lithium metal to create a lithium vapor. The lithium metal can be heated by an electron beam or by resistive heating of the lithium metal. The lithium vapor deposits lithium onto an anode active material layer (e.g., comprising Si particles). To promote the deposition of lithium metal the anode layer can be cooled or maintained at a temperature lower than the temperature of the lithium vapor. A thickness monitor such as a quartz crystal type monitor can be placed near the substrate to monitor the thickness of the film being deposited. Alternatively, laser ablation and sputtering techniques can be used to promote thin lithium film growth on a substrate. For example, argon ions can be used in the sputtering process to bombard a solid lithium metal target. The bombarding knocks lithium off of the target and deposits it on the surface of a substrate. Laser ablation processes can be used to knock lithium off of a lithium target. The separated lithium atoms are then deposited onto the substrate. The lithium-coated layer of bonded Si particles (as an example of an anode active material) in a pre-fabricated anode is then immersed into a liquid electrolyte containing a lithium salt dissolved in an organic solvent. Lithium atoms rapidly permeate into the bulk of Si particles to form prelithiated Si particles. Physical methods may also be conducted by simply mixing molten lithium metal with the anode active materials (e.g., Si, Ge, SiO, Co₃O₄, Sn, SnO₂, ZnCo₂O₄, etc.) provided the binder can tolerate up to the melting point of lithium (181° C.).

A preferred pre-lithiation process involves electro-chemically forcing Li atoms to migrate into the bulk of a CVD Si layer or multiple Si particles under the influence of an electromotive force (emf). In a typical arrangement (as schematically illustrated in FIG. 1(C)), again using Si as an example, an anode active material layer (e.g., having carbon particles as a conductive additive mixed with these Si particles or having individual Si particles coated with a carbon material or embraced with graphene sheets) is used as a working electrode and Li metal sheet or rod as a counter-electrode in the electrochemical reactor. In other words, a pre-fabricated anode electrode (e.g., a silicon-containing electrode) is electrically connected to the negative terminal of an electrical power source and the lithium metal is connected to the positive terminal of the power source. The two electrodes are then immersed in a liquid electrolyte containing a lithium salt dissolved in an organic solvent. An electric current is then applied between the anode and the cathode. This is similar to an electro-plating procedure, but, surprisingly, Li atoms are capable of permeating into the bulk of the Si particles. The pre-fabricated anode serves as a working electrode while a lithium metal rod or sheet serves as a counter electrode. The entire set-up is preferably immersed in a liquid electrolyte contained in an electrochemical reactor.

As the pre-fabricated anode (e.g., silicon-containing electrode) is electrically connected to the negative terminal of the power source and the lithium source is electrically connected to the positive terminal, the lithium salt solution acts as an electrolyte in the system. Accordingly, while current is being applied to the silicon-containing electrode the positively charged lithium ions present in the lithium salt solution are attracted to the negative electrode. In some embodiments, lithium ions present in the lithium salt solution intercalate into the silicon-containing electrode when electrical current is applied thereto. Electrical current may be applied to the silicon-containing electrode for a duration of time until a desired level of lithium intercalation, or prelithiation, has been achieved in the silicon-containing electrode. That is, current may be applied to the silicon-containing electrode until a desired amount of lithium ions have intercalated into the silicon-containing electrode.

After the pre-fabricated anode is pre-lithiated to a desired extent (e.g., up to the full lithium storage capacity of Si or graphite), the electric current is stopped. In some embodiments, the prelithiated anode is then retreated from the electrochemical reactor and deposited with a protective polymer. The application of this protective polymer may be accomplished by polymer solution spraying or by dipping into a polymer solution contained in a liquid chamber or trough. In some embodiments, the electrochemical reactor contains a polymer dissolved in the electrolyte solution. Upon completion of the lithiation procedure, the pre-lithiated anode layer is then retreated from the reactor, allowing for drying of the electrode layer and precipitation of the polymer to coat onto the anode active material.

In summary, as illustrated in FIG. 1(C), step (b) of the disclosed method comprises (i) immersing a pre-fabricated anode and a lithium source (comprising lithium) in the electrolyte solution and (ii) applying a current from an electrical power source between the pre-fabricated anode and the lithium source for a length of time sufficient to achieve the desired level of lithium intercalation. The current from the electric power source preferably results in a current density in the anode of from about 0.05 mA/cm² to about 5 mA/cm². The pre-fabricated anode electrode may be in a roll form. In some embodiments, the lithium salt solution may comprise a lithium salt dissolved in a solvent. In some embodiments the solvent may be an organic solvent and the lithium salt may comprise an organic lithium salt. For example, in some embodiments the lithium salt may comprise Li trans-trans-muconate (Li₂C₆H₄O₄), Lithium oxalate (C₂Li₂O₄), Lithium fumarate (C₄H₂Li₂O₄), Maleic acid, and/or a lithium salt (e.g. C₄H₂Li₂O₄).

Preferably, the anode is prelithiated to a level of lithium interaction from 40% to 100% of the maximum lithium storage capacity, inducing a volume expansion of the anode active material to an extent of from 10% to 380%, followed by introducing the protective polymer to bond the expanded anode active material.

It may be noted that the pre-fabricated anode may contain multiple anode active particles, along with a conductive additive, being bonded by a first binder resin. Alternatively, the anode comprises multiple particles of an anode active material distributed within a carbon phase or the anode comprises a film comprising the anode active material and a carbon phase that holds the film together. In all these situations, the first binder resin or the supporting carbon phase is incapable of holding the anode active material in place when the volume expansion of the anode active material exceeds 10%, 20%, 30%, etc. (up to 380%). Consequently, the anode active material can be either detached from the supporting binder or carbon phase or fragmented into pieces. This could not only make it challenging to handle for subsequent battery cell assembling process but also interrupt the electron- or ion-conducting pathways. This latter phenomenon typically results in rapid capacity decay of the resultant battery. The protective polymer herein introduced can serve as a second binder resin to help hold the expanded anode active material together.

In some embodiments, the anode comprises multiple particles of an anode active material, a conductive additive, and a binder that holds the multiple anode material particles and the conductive additive together to form an anode layer and wherein the protective polymer assists to further hold the expanded particles of the anode active material and the conductive additive together to form an anode of sufficient structural integrity to enable subsequent handling of the anode.

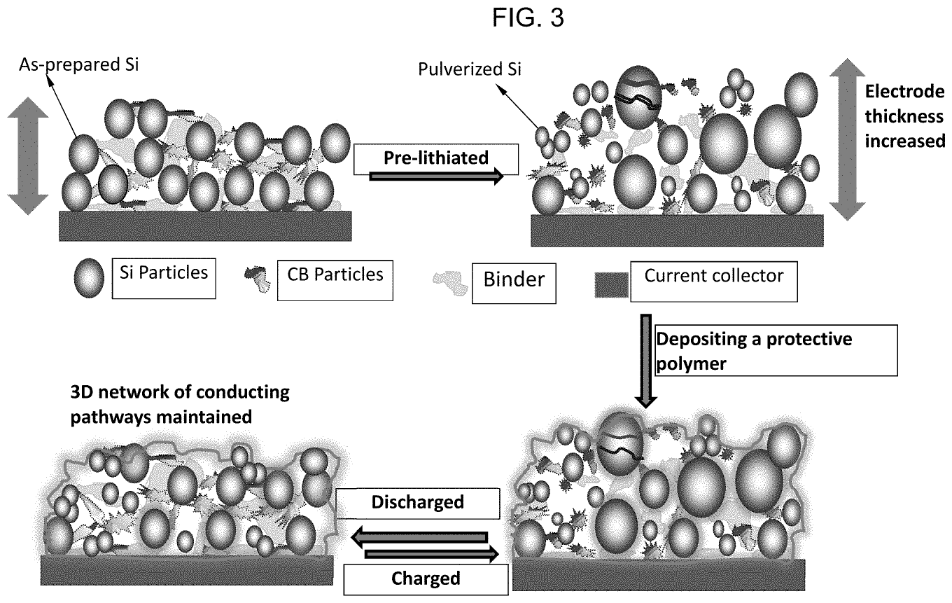

FIG. 3 shows the anode in four different stages. A first stage is shown in the upper left, depicting how the anode might look after the silicon particles, carbon black particles (although other types of conductive additive could be used), and binder has been added to the current collector. A second stage is shown in the upper right, after pre lithiation has occurred. A third stage is shown in the lower right, after a protective polymer has been deposited. This is the charged state for the anode. A fourth stage is shown in the lower left, depicting how the anode might look upon discharge.

The lithium salt in the disclosed method may be selected from lithium hydroxide, LiOH, lithium carbonate, Li₂CO₃, lithium halide, LiX (X═F, Cl, B, or I), lithium methoxide, lithium azide, lithium acetate, lithium acetylacetonate, lithium amide, lithium acetylides, R—Li (R=alkyl and aryl), R₃DLi derivatives, where D=Si, Ge, Sn and R=alkyl or aryl, lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium trifluoromethanesulfonimide (LiTFSI), lithium oxalyldifluoroborate (LiODFB), LiPF₃(CF₂CF₃)₃(LiFAP), LiBF₃(CF₂CF₃)₃(LiFAB), LiN(C₂F₅SO₂)₂, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), a lithium salt having a cyclic alkyl group, an ionic liquid-based lithium salt, or a combination thereof. It may be noted that these metal salts are also commonly used in the electrolytes of rechargeable lithium batteries.

The electrolytes used in this electrochemical reactor for lithiating may contain a solvent selected from any solvent commonly used for an operating lithium ion battery. Examples of non-aqueous solvents suitable for some lithium ion cells include the following: cyclic carbonates (e.g., ethylene carbonate (EC), propylene carbonate (PC), butylene carbonate (BC) and vinylethylene carbonate (VEC)), linear carbonates (e.g., dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)), fluorinated versions of the cyclic and linear carbonates (e.g., monofluoroethylene carbonate (FEC)), lactones (e.g., gamma-butyrolactone (GBL), gamma-valerolactone (GVL) and alpha-angelica lactone (AGL)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

In certain embodiments, the protective polymer comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

In certain embodiments, the protective polymer comprises a high-elasticity polymer having a recoverable elastic strain from 5% to 1,000% when measured under tension.

The high-elasticity polymer preferably comprises an elastomer selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, vinyl acetate-acrylic copolymer rubber, silicone rubber, fluorosilicone rubber, perfluoroelastomers, polyether block amides, chlorosulfonated polyethylene, ethylene-vinyl acetate, polysulphide rubber, polypropylene oxide rubber, polypropylene oxide-allyl glycidyl ether copolymer rubber, thermoplastic elastomer, protein resilin, protein elastin, ethylene oxide-epichlorohydrin copolymer, polyurethane, urethane-urea copolymer, urethane-acrylic copolymer, a sulfonated version thereof, or a combination thereof.

An elastic deformation is a deformation that is fully recoverable and the recovery process is essentially instantaneous (no significant time delay). The high-elasticity polymer can exhibit an elastic deformation from 5% up to 1,500% (15 times of its original length), more typically from 10% to 800%, and further more typically from 50% to 500%, and most typically and desirably from 70% to 300%. It may be noted that although a metal typically has a high ductility (i.e. can be extended to a large extent without breakage), the majority of the deformation is plastic deformation (non-recoverable) and only a small amount of elastic deformation (typically <1% and more typically <0.2%).

In some embodiments, the high-elasticity polymer comprises a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

The aforementioned prelithiation processes are applicable to all of the anode active materials discussed in the present specification, not just Si and graphite, although Si and graphite are used as an example to illustrate the best-mode practice. The anode active material preferably comprises silicon and the prelithiated particles comprise a prelithiated silicon, represented by Li₄Si, Li_{4.4}Si, or LiₓSi, wherein numerical x is between 1 and 4.4. The step of providing an anode active material may comprise providing a doped semiconductor material. Such a doped semiconductor material may be selected from Si or Ge doped with n-type and/or p-type dopants. Commonly used n-type dopants are P, As, and Sb and commonly used p-type dopants are Al, Ga, and In.

The protective polymer layer described in this disclosure typically exhibits a lithium ion conductivity from 1.0×10⁻⁸ S/cm to 5.0×10⁻² S/cm, more typically from 1×10⁻⁷ S/cm to 5×10⁻³ S/cm, and further more typically >10⁻⁵ S/cm, and most typically and preferably >10-4 S/cm. The protecting polymer may be cast into a thin film to allow for ion conductivity measurement.

In some embodiments, the high-elasticity polymer is a neat polymer having no additive or filler dispersed therein. In others, the high-elasticity polymer is a polymer matrix composite containing from 0.1% to 50% (preferably 1% to 35%) by weight of a lithium ion-conducting additive dispersed in a high-elasticity polymer matrix material. The high-elasticity polymer must have a high elasticity (elastic deformation strain value >5%). An elastic deformation is a deformation that is fully recoverable and the recovery process is essentially instantaneous (no significant time delay). The high-elasticity polymer can exhibit an elastic deformation from 5% up to 1,500%, more typically from 10% to 800%, and further more typically from 50% to 500%, and most typically and desirably from 70% to 300%.

In some preferred embodiments, the high-elasticity polymer contains a lightly cross-linked network polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof, in the cross-linked network of polymer chains. These network or cross-linked polymers exhibit a unique combination of a high elasticity (high elastic deformation strain) and high lithium-ion conductivity.

In certain preferred embodiments, the high-elasticity polymer contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, or a combination thereof.

Typically, a high-elasticity polymer is originally in a monomer or oligomer states that can be cured to form a cross-linked polymer that is highly elastic. Prior to curing, these polymers or oligomers are soluble in an organic solvent to form a polymer solution. An ion-conducting or electron-conducting additive may be added to this solution to form a suspension. This solution or suspension can then be formed into a thin layer of polymer precursor on a surface of a prelithiated anode. The polymer precursor (monomer or oligomer and initiator) is then polymerized and cured to form a lightly cross-linked polymer. This thin layer of polymer may be tentatively deposited on a solid substrate (e.g., surface of a polymer or glass), dried, and separated from the substrate to become a free-standing polymer layer. This free-standing layer is then laid on a surface of the prelithiated anode. Polymer layer formation can be accomplished by using one of several procedures well-known in the art; e.g. spraying, spray-painting, printing, coating, dipping, extrusion-based film-forming, casting, etc.

For instance, ethoxylated trimethylopropane triacrylate monomer (ETPTA, Mw=428, chemical formula given below), along with an initiator, can be dissolved in an organic solvent, such as ethylene carbonate (EC) or diethyl carbonate (DEC). Then, the ETPTA monomer/solvent/initiator solution may be cast to form ETPTA a monomer/initiator layer on a glass surface. The layer can then be thermally cured to obtain a thin layer of a high-elasticity polymer. The polymerization and cross-linking reactions of this monomer can be initiated by a radical initiator derived from benzoyl peroxide (BPO) or AIBN through thermal decomposition of the initiator molecule. The ETPTA monomer has the following chemical formula:

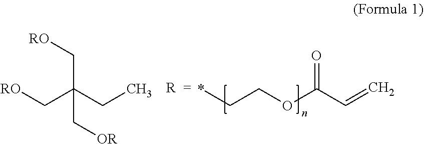

As another example, the high-elasticity polymer for anode lithium foil/coating protection may be based on cationic polymerization and cross-linking of the cyanoethyl polyvinyl alcohol (PVA-CN, Formula 2) in succinonitrile (SN).

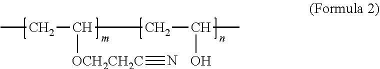

The procedure may begin with dissolving PVA-CN in succinonitrile (NCCH₂CH₂CN) to form a mixture solution. This is followed by adding an initiator into the mixture solution. For instance, LiPF₆ can be added into the PVA-CN/SN mixture solution at a weight ratio (selected from the preferred range from 20:1 to 2:1) to form a precursor solution. Then, the solution may be deposited to form a thin layer of reacting mass, PVA-CN/LiPF₆, which is subsequently heated at a temperature (e.g. from 75 to 100° C.) for 2 to 8 hours to obtain a high-elasticity polymer. During this process, cationic polymerization and cross-linking of cyano groups on the PVA-CN may be initiated by PF₅, which is derived from the thermal decomposition of LiPF₆ at such an elevated temperature.

It is essential for these materials to form a lightly cross-linked network of polymer chains. In other words, the network polymer or cross-linked polymer should have a relatively low degree of cross-linking or low cross-link density to impart a high elastic deformation.

The cross-link density of a cross-linked network of polymer chains may be defined as the inverse of the molecular weight between cross-links (Mc). The cross-link density can be determined by the equation, Mc=ρRT/Ge, where Ge is the equilibrium modulus as determined by a temperature sweep in dynamic mechanical analysis, ρ is the physical density, R is the universal gas constant in J/mol*K and T is absolute temperature in K. Once Ge and ρ are determined experimentally, then Mc and the cross-link density can be calculated.

The magnitude of Mc may be normalized by dividing the Mc value by the molecular weight of the characteristic repeat unit in the cross-link chain or chain linkage to obtain a number, Nc, which is the number of repeating units between two cross-link points. We have found that the elastic deformation strain correlates very well with Me and Nc. The elasticity of a cross-linked polymer derives from a large number of repeating units (large Nc) between cross-links. The repeating units can assume a more relax conformation (e.g. random coil) when the polymer is not stressed. However, when the polymer is mechanically stressed, the linkage chain uncoils or gets stretched to provide a large deformation. A long chain linkage between cross-link points (larger Nc) enables a larger elastic deformation. Upon release of the load, the linkage chain returns to the more relaxed or coiled state. During mechanical loading of a polymer, the cross-links prevent slippage of chains that otherwise form plastic deformation (non-recoverable).

Preferably, the Nc value in a high-elasticity polymer is greater than 5, more preferably greater than 10, further more preferably greater than 100, and even more preferably greater than 200. These Nc values can be readily controlled and varied to achieve different elastic deformation values by using different cross-linking agents with different functionalities, and by designing the polymerization and cross-linking reactions to proceed at different temperatures for different periods of time.

Alternatively, Mooney-Rilvin method may be used to determine the degree of cross-linking. Crosslinking also can be measured by swelling experiments. In a swelling experiment, the crosslinked sample is placed into a good solvent for the corresponding linear polymer at a specific temperature, and either the change in mass or the change in volume is measured. The higher the degree of crosslinking, the less swelling is attainable. Based on the degree of swelling, the Flory Interaction Parameter (which relates the solvent interaction with the sample, Flory Huggins Eq.), and the density of the solvent, the theoretical degree of crosslinking can be calculated according to Flory's Network Theory. The Flory-Rehner Equation can be useful in the determination of cross-linking.

The high-elasticity polymer may contain a simultaneous interpenetrating network (SIN) polymer, wherein two cross-linking chains intertwine with each other, or a semi-interpenetrating network polymer (semi-IPN), which contains a cross-linked polymer and a linear polymer. An example of semi-IPN is an UV-curable/polymerizable trivalent/monovalent acrylate mixture, which is composed of ethoxylated trimethylolpropane triacrylate (ETPTA) and ethylene glycol methyl ether acrylate (EGMEA) oligomers. The ETPTA, bearing trivalent vinyl groups, is a photo (UV)-crosslinkable monomer, capable of forming a network of cross-linked chains. The EGMEA, bearing monovalent vinyl groups, is also UV-polymerizable, leading to a linear polymer with a high flexibility due to the presence of the oligomer ethylene oxide units. When the degree of cross-linking of ETPTA is moderate or low, the resulting ETPTA/EGMEA semi-IPN polymer provides good mechanical flexibility or elasticity and reasonable mechanical strength. The lithium-ion conductivity of this polymer is in the range from 10-4 to 5×10⁻³ S/cm.

The aforementioned high-elasticity polymers may be used alone to protect the lithium foil/coating layer at the anode. Alternatively, the high-elasticity polymer can be mixed with a broad array of elastomers, electrically conducting polymers, lithium ion-conducting materials, and/or strengthening materials (e.g., carbon nanotube, carbon nano-fiber, or graphene sheets).

A broad array of elastomers can be used alone as a protective polymer or mixed with a high-elasticity polymer to form a blend, co-polymer, or interpenetrating network that encapsulates the cathode active material particles. The elastomeric material may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, sulfonated versions thereof, and combinations thereof.

The urethane-urea copolymer film usually consists of two types of domains, soft domains and hard ones. Entangled linear backbone chains consisting of poly (tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

The high-elasticity polymer may form a mixture, blend, or semi-interpenetrating network with an electron-conducting polymer selected from polyaniline, polypyrrole, polythiophene, polyfuran, a bi-cyclic polymer, derivatives thereof (e.g., sulfonated versions), or a combination thereof. In some embodiments, the high-elasticity polymer may form a mixture, co-polymer, or semi-interpenetrating network with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazene, Polyvinyl chloride, Polydimethylsiloxane, poly(vinylidene fluoride)-hexafluoropropylene (PVDF-HFP), a derivative thereof (e.g. sulfonated versions), or a combination thereof.

Unsaturated rubbers that can be mixed with the high-elasticity polymer include natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR),

Some elastomers are saturated rubbers that cannot be cured by sulfur vulcanization; they are made into a rubbery or elastomeric material via different means: e.g., by having a copolymer domain that holds other linear chains together. Each of these elastomers can be used to bond particles of an anode active material or to coat on surfaces of a prelithiated anode layer by one of several means; e.g. spray coating, dilute solution mixing or dipping (dissolving an uncured polymer in a solvent or a monomer or oligomer, with or without an organic solvent) followed by drying and curing.

Saturated rubbers and related elastomers in this category include EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, and protein elastin. Polyurethane and its copolymers (e.g. urea-urethane copolymer) are particularly useful elastomeric shell materials for encapsulating anode active material particles.

The disclosure also provides a lithium-ion cell comprising the disclosed prelithiated anode, a cathode comprising a cathode active material, an ion-permeable separator disposed between the prelithiated anode and the cathode. The cathode may be produced by any known process; e.g., the commonly used slurry coating and drying procedure. There is no restriction on the types of cathode materials or the processes that can be used.

The cathode active material may be selected from an inorganic material, an organic material, a polymeric material, or a combination thereof. In general, in order to make use of a cathode active material having no lithium contained in the cathode material structure (e.g., CoF₃, MnF₃, FeF₃, TiS₂, TaS₂, MoS₂, NbSe₃, MnO₂, CoO₂, etc.), the anode is preferably prelithiated to at least 40%, and more preferably from 50% to 100%. For a lithiated cathode active material (e.g., lithium transition metal oxides such as NCM and NCA), the anode may be prelithiated to less than 40%.

The inorganic material may be selected from a metal oxide, metal phosphate, metal silicide, metal selenide, transition metal sulfide, sulfur, lithium polysulfide, selenium, lithium selenide, or a combination thereof. In some embodiments, the inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, or V, Mb is selected from Fe, Mn, Co, Ni, V, Ti, Al, B, Sn, or Bi; and x+y≤1. Examples of the lithium transition metal oxide- or lithium mixed transition metal oxide-based positive active materials include: Li(M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂), Li(Co_{X}M_{1-X})O₂, where M is a metal, (e.g. Li(Co_{X}Ni_{1-X})O₂ and Li(Co_{X}Fe_{1-X})O₂), Li_{1-w}(Mn_{X}Ni_{Y}Co_{Z})O₂, (e.g. Li(Co_{X}Mn_{Y}Ni_{(1-X-Y)})O₂, Li(Mn_{1/3}Ni_{1/3}Co_{1/3})O₂, Li(Mn_{1/3}Ni_{1/3}Co_{1/3-X}Mg_{X})O₂, Li(Mn_{0.4}Ni_{0.4}Co_{0.2})O₂, Li(Mn_{0.1}Ni_{0.1}Co_{0.8})O₂), Li_{1-W}(Mn_{X}Ni_{X}Co_{1-2X})O₂, Li_{1-W} Mn_{X}Ni_{Y}CoAl_{W})O₂, Li_{1-W} (Ni_{X}Co_{Y}Al_{Z})O₂, where W=0-1, (e.g., Li(Ni_{0.8}Co_{0.15}Al_{0.05})O₂), Li_{1-w}(Ni_{X}Co_{Y}M_{Z})O₂, where M is a metal, Li_{1-W}(Ni_{X}Mn_{Y}M_{Z})O₂, where M is a metal, Li(Ni_{X}Mn_{Y}Cr_{2-X})O₄, LiM′M″₂O₄, where M′ and M″ are different metals (e.g., LiMn_{2-Y-Z}Ni_{Y}O₄, LiMn_{2-Y-Z}Ni_{Y}Li_{Z}O₄, LiMn_{1.5}Ni_{0.5}O₄, LiNiCuO₄, LiMn_{1-X}Al_{X}O₄, LiNi_{0.5}Ti_{0.5}O₄, Li_{1.05}Al_{0.1}Mn_{1.85}O_{4-Z}F_{Z}, Li₂MnO₃)Li_{X}V_{Y}O_{Z}, e.g. LiV₃O₈, LiV₂O₅, and LiV₆O₁₃.

The metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In certain desired embodiments, the inorganic material is selected from a lithium-free cathode material. Such an initially lithium-free cathode may contain a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In these cases, it is particularly desirable to have the anode active material prelithiated to a high level, preferably no less than 50%.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide or metal phosphate may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The organic material or polymeric material may be selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer is selected from Poly[methanetetryl-tetra(thiomethylene)](PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

The organic material may contain a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

The following examples serve to provide the best modes of practice for the present disclosure and should not be construed as limiting the scope of the disclosure:

### Example 1: Prelithiated Cobalt Oxide (Co₃O₄) Anode

An appropriate amount of inorganic salts Co(NO₃)₂.6H₂O and ammonia solution (NH₃.H₂O, 25 wt. %) were mixed together. The resulting suspension was stirred for 2 hours under an argon flow to ensure a complete reaction. The obtained Co(OH)₂ precursor suspension was calcined at 450° C. in air for 2 h to form particles of the layered Co₃O₄. Portion of the Co₃O₄ particles was then encapsulated with a phenolic resin, which was then carbonized at 500° C. for 2 hours and 900° C. for another 2 hours to obtain carbon-coated Co₃O₄ particles.

Several anode electrodes were prepared by mixing 85 wt. % active material (carbon-protected or non-protected particulates of Co₃O₄), 7 wt. % graphite particles, and 8 wt. % polyvinylidene fluoride (PVDF) binder dissolved in N-methyl-2-pyrrolidinone (NMP) to form a slurry containing 5 wt. % total solid content. After coating the slurries on Cu foil, the electrodes were dried at 120° C. in vacuum for 2 h to remove the solvent. These pre-fabricated anode electrodes were then subjected to a pre-lithiation treatment using the electrochemical reactor as illustrated in 1(C). The degree of polymerization was set to be approximately 30%. The pre-lithiated anodes were then surface-protected by a layer of poly(vinylidene fluoride)-hexafluoropropylene (PVDF-HFP co-polymer). The solvent used to dissolve PVDF-HFP was acetone.

Then, the electrodes were cut into a disk (ϕ=12 mm) and dried at 100° C. for 24 h in vacuum. Electrochemical measurements were carried out using CR2032 (3V) coin-type cells with a LiCoO₂ cathode, Celgard 2400 membrane as a separator, and 1 M LiPF₆ electrolyte solution dissolved in a mixture of ethylene carbonate (EC) and diethyl carbonate (DEC) (EC-DEC, 1:1 v/v). The cell assembling procedure was performed in an argon-filled glove-box. The CV measurements were carried out using an electrochemical workstation at a scanning rate of 1 mV/s.

The electrochemical performance of the prelithiated Co₃O₄-based anodes and that of non-prelithiated Co₃O₄ anodes were evaluated by galvanostatic charge/discharge cycling at a current density of 50 mA/g, using an electrochemical workstation. In general, the prelithiated anodes exhibit a significantly higher first-cycle efficiency (lower initial capacity loss). The initial capacity loss likely has resulted mainly from the formation of solid electrolyte interface (SEI) layers on the surfaces of anode active material particles and some lithium ions being trapped inside the defects of the anode active materials. The prelithiated anode with a protective polymer further exhibits a longer cycle life possibly due to a more robust electrode structure.

### Example 2: Polymer-Protected Prelithiated Anode of Tin Oxide Particles

Tin oxide (SnO₂) nano particles were obtained by the controlled hydrolysis of SnCl₄.5H₂O with NaOH using the following procedure: SnCl₄.5H₂O (0.95 g, 2.7 m-mol) and NaOH (0.212 g, 5.3 m-mol) were dissolved in 50 mL of distilled water each. The NaOH solution was added drop-wise under vigorous stirring to the tin chloride solution at a rate of 1 mL/min. This solution was homogenized by sonication for 5 m in. Subsequently, the resulting hydrosol was reacted with H₂SO₄. To this mixed solution, few drops of 0.1 M of H₂SO₄ were added to flocculate the product. The precipitated solid was collected by centrifugation, washed with water and ethanol, and dried in vacuum. The dried product was heat-treated at 400° C. for 2 h under Ar atmosphere to obtain SnO₂ nano particles.

Several anode electrodes were prepared by mixing 85 wt. % active material (SnO₂ nano particles), 7 wt. % super-P particles, and 8 wt. % polyacrylic acid binder to form a slurry in water. The slurry was coated on a Cu foil surface and dried to produce a pre-fabricated anode.

Several rolls of the pre-fabricated anode were subjected to electrochemical prelithiation to different extents (10-35% degree of prelithiation) using lithium hexafluorophosphate (LiPF₆) as the salt dissolved in EC-PC (50/50) as an electrolyte solution and lithium metal as a counter-electrode. The pre-lithiated anode layers were then sprayed with a poly(acrylonitrile) (PAN)-solvent solution, followed by removal of the solvent to produce PAN-protected prelithiated anodes. These anodes were paired up with several different cathode layers to prepare lithium-ion cells. These cathodes were based on the well-known NCM-532, NCA, and LFP particles, respectively.

### Example 3: Polymer-Protected Prelithiated Anodes Comprising Silicon (Si) Particles

Sub-micron sized Si particles were encapsulated with a thin layer of phenolic resin shell via the spray-drying method, followed by a heat treatment from 350-600° C. for 4 hours to obtain carbon-coated Si particles. A portion of these C-coated Si particles was combined with 10% acetylene black (a conductive additive), and a CMC binder resin to form a layer of pre-fabricated anode bonded to a Cu foil using the slurry coating procedure. A thin layer of lithium metal film was then attached to a surface of the pre-fabricated anode and the resulting laminate (consisting of the Cu foil, a Si-based active material layer, and a lithium metal film) was then immersed in a lithium salt solution containing LiPF₆ salt dissolved in EC-PC (50/50) as an electrolyte solution. This creates an electrically shorting condition, allowing lithium ions to rapidly diffuse into the bulk of Si particles. Typically, a degree of prelithiation of 80-100% was obtained. However, due to the relatively violent conditions involving a large volume expansion of Si, a protective polymer was needed to serve as a second binder and a protective coating. Polyethylene glycol methyl ether (PEG-me) was used as the protective polymer, which was deposited onto the prelithiated anode layer via spraying with a PEG-me/ethanol solution, followed by ethanol removal.

These Si-rich anodes, upon prelithiation and proper polymer protection, were used to pair up with initially lithium-free cathode materials (e.g., FeF₃, CuF₂, and MoS₂) for forming lithium-ion cells.

### Example 4: Polymer-Protected Prelithiated Anodes of Si Nanowire-Based Anode Materials

Si nanowires, having a diameter range from 19 to 28 nm, were supplied from Angstron Energy Co. (Dayton, Ohio). Some Si nanowires were coated with a layer of graphene sheets using spray-drying of Si nanowire/graphene oxide/water suspension. The graphene-coated Si nanowires, along with carbon nanotubes (CNTs) and 5% polyacrylic acid binder, were then made into anode electrode rolls, which were prelithiated in an electrochemical reactor up to approximately 100% capacity. Different protective polymers were then deposited to protect the prelithiated anodes as discussed in Examples 5-7 below.

### Example 5: Lithium Battery Containing a High-Elasticity Polymer-Protected Prelithiated Si Anode and a Cathode Containing V₂O₅ Particles

Cathode active material layers were prepared from V₂O₅ particles and graphene-embraced V₂O₅ particles, respectively. The V₂O₅ particles were commercially available. Graphene-embraced V₂O₅ particles were prepared in-house. In a typical experiment, vanadium pentoxide gels were obtained by mixing V₂O₅ in a LiCl aqueous solution. The Li⁺-exchanged gels obtained by interaction with LiCl solution (the Li:V molar ratio was kept as 1:1) was mixed with a GO suspension and then placed in a Teflon-lined stainless steel 35 ml autoclave, sealed, and heated up to 180° C. for 12 h. After such a hydrothermal treatment, the green solids were collected, thoroughly washed, ultrasonicated for 2 minutes, and dried at 70° C. for 12 h followed by mixing with another 0.1% GO in water, ultrasonicating to break down nano-belt sizes, and then spray-drying at 200° C. to obtain graphene-embraced V₂O₅ composite particulates. Selected amounts of V₂O₅ particles and graphene-embraced V₂O₅ particles, respectively, were then each made into a cathode layer following a well-known slurry coating process.

The ethoxylated trimethylopropane triacrylate monomer (ETPTA, Mw=428, Sigma-Aldrich) was dissolved in a solvent mixture of ethylene carbonate (EC)/diethyl carbonate (DEC), at a weight-based composition ratios of the ETPTA/solvent of 3/97 (w/w). Subsequently, benzoyl peroxide (BPO, 1.0 wt. % relative to the ETPTA content) was added as a radical initiator to allow for thermal crosslinking reaction upon deposition on a surface of a prelithiated anode layer (e.g., as prepared in Example 4). This layer of ETPTA monomer/initiator was then thermally cured at 60° C. for 30 min to obtain a protective layer.

On a separate basis, some amount of the ETPTA monomer/solvent/initiator solution was cast onto a glass surface to form a wet film, which was thermally dried and then cured at 60° C. for 30 min to form a film of cross-linked polymer. In this experiment, the BPO/ETPTA weight ratio was varied from 0.1% to 4% to vary the degree of cross-linking in several different polymer films. Some of the cured polymer samples were subjected to dynamic mechanical testing to obtain the equilibrium dynamic modulus, Ge, for the determination of the number average molecular weight between two cross-link points (Mc) and the corresponding number of repeat units (Nc), as a means of characterizing the degree of cross-linking. The typical and preferred number of repeat units (Nc) is from 5 to 5,000, more preferably from 10 to 1,000, further preferably from 20 to 500, and most preferably from 50 to 500.

Several tensile testing specimens were cut from each cross-link film and tested with a universal testing machine. This series of network polymers can have an elastic deformation from approximately >200%.

For electrochemical testing, the working electrodes (cathode layers) were prepared by mixing 85 wt. % V₂O₅ or 88% of graphene-embraced V₂O₅ particles, 5-8 wt. % CNTs, and 7 wt. % polyvinylidene fluoride (PVDF) binder dissolved in N-methyl-2-pyrrolidinone (NMP) to form a slurry of 5 wt. % total solid content. After coating the slurries on Al foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were carried out using CR2032 (3V) coin-type cells each comprising a polymer-protected prelithiated anode electrode, Celgard 2400 membrane as a separator, and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The CV measurements were carried out using a CH-6 electrochemical workstation at a scanning rate of 1 mV/s. The electrochemical performance of the cell featuring high-elasticity polymer binder and that containing PVDF binder were evaluated by galvanostatic charge/discharge cycling at a current density of 50 mA/g using an Arbin electrochemical workstation.

The high-elasticity cross-linked ETPTA polymer protective layer appears to be capable of reversibly deforming to a great extent without breakage when the anode layer decreases in thickness during battery discharge. The protective polymer layer also prevents the continued reaction between liquid electrolyte and the anode active material (e.g., Si in this case), reducing the problem of continuing loss in lithium ions and electrolyte.

### Example 6: High-Elasticity Polymer Protected, Prelithiated Si Anode Implemented in the Si-LiCoO₂ Cells

The high-elasticity polymer for anode protection was based on cationic polymerization and cross-linking of the cyanoethyl polyvinyl alcohol (PVA-CN) in succinonitrile (SN). The procedure began with dissolving PVA-CN in succinonitrile to form a mixture solution. This step was followed by adding an initiator into the solution. For the purpose of incorporating some lithium species into the high elasticity polymer, we chose to use LiPF₆ as an initiator. The ratio between LiPF₆ and the PVA-CN/SN mixture solution was varied from 1/20 to ½ by weight to form a series of precursor solutions. Subsequently, these solutions were separately spray-deposited to form a thin layer of precursor reactive mass onto a surface of a prelithiated Si anode layer. The precursor reactive mass was then heated at a temperature from 75 to 100° C. for 2 to 8 hours to obtain a layer of high-elasticity polymer adhered to the anode active material surface.

### Example 7: High-Energy Density Lithium-Ion Cells Containing Metal Fluoride Nano Particle-Based Cathode and a PETEA-Based High-Elasticity Polymer-Protected Prelithiated Si Anode

For serving as a prelithiated anode-protecting layer, pentaerythritol tetraacrylate (PETEA), Formula 3, was used as a monomer:

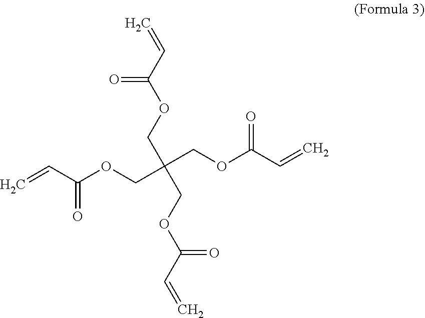 [SMILES: C=CC(=O)OCC(COC(=O)C=C)(COC(=O)C=C)COC(=O)C=C]

In a representative procedure, the precursor solution was composed of 1.5 wt. % PETEA (C₁₇H₂₀O₈) monomer and 0.1 wt. % azodiisobutyronitrile (AIBN, C₈H₁₂N₄) initiator dissolved in a solvent mixture of 1,2-dioxolane (DOL)/dimethoxymethane (DME)(1:1 by volume). The PETEA/AIBN precursor solution was cast onto a prelithiated Si anode supported by a Cu foil to form a precursor film, which was polymerized and cured at 70° C. for half an hour to obtain a lightly cross-linked polymer.

Commercially available powders of CoF₃, MnF₃, FeF₃, VF₃, VOF₃, TiF₃, and BiF₃ were subjected to high-intensity ball-milling to reduce the particle size down to approximately 0.5-2.3 μm. Each type of these metal fluoride particles, along with graphene sheets (as a conductive additive), was then added into an NMP and PVDF binder suspension to form a multiple-component slurry. The slurry was then slurry-coated on Al foil to form cathode layers. A cathode layer, a separator, and a polymer-protected prelithiated anode layer were then combined to form a lithium-ion cell.

It was found that the high-elasticity polymer protection strategy provides excellent protection against capacity decay of a lithium-ion battery. The high-elasticity polymer appears to be capable of reversibly deforming without breakage when the anode layer expands and shrinks during charge and discharge. The polymer also prevents continued reaction between the liquid electrolyte and the anode active material.

### Example 8: Lithiated Si Anode-Organic Cathode Cell Containing a Naphthalocyanine/Reduced Graphene Oxide (FePc/RGO) Hybrid Particulate Cathode and a High Elasticity Polymer-Protected Si Anode

Particles of combined FePc/graphene sheets were obtained by ball-milling a mixture of FePc and RGO in a milling chamber for 30 minutes. The resulting FePc/RGO mixture particles were potato-like in shape. Some of these mixture particles were encapsulated by an UHMW PAN polymer using the pan-coating procedure. Two lithium cells were prepared, each containing a prelithiated Si anode, a porous separator, and a cathode layer of FePc/RGO particles (encapsulated or un-encapsulated).

For preparation of an ETPTA semi-IPN polymer to protect the prelithiated Si anode as prepared in Example 3, the ETPTA (Mw=428 g/mol, trivalent acrylate monomer), EGMEA (Mw=482 g/mol, monovalent acrylate oligomer), and 2-hydroxy-2-methyl-1-phenyl-1-propanone (HMPP, a photoinitiator) were dissolved in a solvent (propylene carbonate, PC) to form a solution. The weight ratio between HMPP and the ETPTA/EGMEA mixture was varied from 0.2% to 2%. The ETPTA/EGMEA proportion in the solution was varied from 1% to 5% to generate different anode-protecting layer thicknesses. The ETPTA/EGMEA ratio in the acrylate mixture was varied from 10/0 to 1/9.

### Example 9: Li—S Cells Containing a Polymer-Protected Fully Prelithiated Si Anode and a Cathode Containing Sulfur-Impregnated Activated Carbon Particles

One way to combine sulfur with a conducting material (e.g. carbon/graphite particles) is to use a solution or melt mixing process. Highly porous activated carbon particles, chemically etched meso-carbon micro-balls (activated MCMBs), and exfoliated graphite worms were mixed with sulfur melt at 117-120° C. (slightly above the melting point of S, 115.2° C.) for 10-60 minutes to obtain sulfur-impregnated carbon particles. Since the cathode active material, S, does not contain any lithium, the anode must be a lithiated material; herein a fully prelithiated Si anode was used.

1.-20. (canceled)

21. A prelithiated anode for a lithium-ion battery, the anode comprising (A) an anode active material having a maximum lithium storage capacity, wherein the anode active material is prelithiated to a level of lithium interaction or degree of prelithiation from 5% to 100% of the maximum lithium storage capacity; and (B) a protective polymer that prevents exposure of the prelithiated anode active material to the open air or bonds the prelithiated anode active material for improving a structural integrity of the prelithiated anode, wherein the protective polymer has a lithium-ion conductivity from 10-8 S/cm to 5×10⁻² S/cm at room temperature.

22. The prelithiated anode of claim 21, wherein the protective polymer contains a lithium salt dispersed in the polymer and the lithium salt is selected from the group consisting of lithium methoxide, lithium azide, lithium halides, lithium acetate, lithium acetylacetonate, lithium amides, lithium acetylides, R—Li (R=alkyl and aryl), R₃DLi derivatives, where D=Si, Ge, Sn and R=alkyl or aryl, lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium trifluoromethanesulfonimide (LiTFSI), lithium oxalyldifluoroborate (LiODFB), LiPF₃(CF₂CF₃)₃(LiFAP), LiBF₃(CF₂CF₃)₃(LiFAB), LiN(C₂F₅SO₂)₂, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), a lithium salt having a cyclic alkyl group, an ionic liquid-based lithium salt, and combinations thereof.

23. The prelithiated anode of claim 21, wherein the anode comprises multiple particles of an anode active material, an optional conductive additive, and a first binder that holds the multiple anode material particles and the conductive additive together to form an anode layer that is optionally supported on a primary surface of a current collector.

24. The prelithiated anode of claim 23, wherein the anode also includes a conductive additive, and the first binder holds the multiple anode material particles and the conductive additive together to form the anode layer.

25. The prelithiated anode of claim 23, wherein the anode layer is supported on a primary surface of a current collector.

26. The prelithiated anode of claim 21, wherein the anode comprises multiple particles of an anode active material distributed within a carbon phase.

27. The prelithiated anode of claim 21, wherein the anode comprises a film comprising the anode active material and a carbon phase that holds the film together.

28. The prelithiated anode of claim 21, wherein the anode active material is selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium niobate, lithium transition metal oxide; (f) carbon or graphite particles; and (g) combinations thereof.

29. The prelithiated anode of claim 21, wherein the anode active material is selected from silicon (Si), germanium (Ge), phosphorus (P), tin (Sn), SiOₓ (0<x<2.0), SnO₂, or a combination thereof.

30. The prelithiated anode of claim 26, wherein the conductive additive is selected from carbon black, acetylene black, graphene, carbon particles, graphite flakes, carbon nanotubes, carbon fibers, needle coke, amorphous carbon, conducting polymer, metal, conductive composite, or a combination thereof and wherein said graphene is selected from pristine graphene, graphene fluoride, graphene chloride, graphene bromide, graphene iodide, nitrogenated graphene, hydrogenated graphene, doped graphene, chemically functionalized graphene, a combination thereof, or a combination thereof with graphene oxide or reduced graphene oxide.

31. The prelithiated anode of claim 21, wherein the anode active material is intercalated to a degree of prelithiation from 30% to 100% of the maximum lithium storage capacity

32. The prelithiated anode of claim 21, wherein said protective polymer comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

33. The prelithiated anode of claim 21, wherein the protective polymer comprises a high-elasticity polymer having a recoverable elastic strain from 5% to 1,000% when measured under tension.

34. The prelithiated anode of claim 33, wherein the high-elasticity polymer comprises an elastomer selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, vinyl acetate-acrylic copolymer rubber, silicone rubber, fluorosilicone rubber, perfluoroelastomers, polyether block amides, chlorosulfonated polyethylene, ethylene-vinyl acetate, polysulphide rubber, polypropylene oxide rubber, polypropylene oxide-allyl glycidyl ether copolymer rubber, thermoplastic elastomer, protein resilin, protein elastin, ethylene oxide-epichlorohydrin copolymer, polyurethane, urethane-urea copolymer, urethane-acrylic copolymer, a sulfonated version thereof, or a combination thereof.

35. The prelithiated anode of claim 33, wherein the high-elasticity polymer comprises a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

36. A lithium-ion cell comprising the prelithiated anode of claim 21, a cathode comprising a cathode active material, an ion-permeable separator disposed between the prelithiated anode and the cathode.

37. The lithium-ion cell of claim 36, wherein said cathode active material is selected from an inorganic material, an organic material, a polymeric material, or a combination thereof.

38. The lithium-ion cell of claim 37, wherein said inorganic material is selected from a metal oxide, metal phosphate, metal silicide, metal selenide, transition metal sulfide, sulfur, lithium polysulfide, selenium, lithium selenide, or a combination thereof.

39. The lithium-ion cell of claim 37, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

40. The lithium-ion cell of claim 37, wherein said inorganic material is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof.

41. The lithium-ion cell of claim 37, wherein said inorganic material is selected from a lithium transition metal silicate, denoted as Li₂MSiO₄ or Li₂MaₓMb_{y}SiO₄, wherein M and Ma are selected from Fe, Mn, Co, Ni, or V; Mb is selected from Fe, Mn, Co, Ni, V, Ti, Al, B, Sn, or Bi; and x+y≤1.

42. The lithium-ion cell of claim 37, wherein said inorganic material is selected from a transition metal dichalcogenide, a transition metal trichalcogenide, or a combination thereof.

43. The lithium-ion cell of claim 37, wherein said inorganic material is selected from TiS₂, TaS₂, MoS₂, NbSe₃, MnO₂, CoO₂, an iron oxide, a vanadium oxide, or a combination thereof.

44. The lithium-ion cell of claim 37, wherein said metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

45. The lithium-ion cell of claim 37, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

46. The lithium-ion cell of claim 37, wherein said inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

47. The lithium-ion cell of claim 37, wherein said organic material or polymeric material is selected from Poly(anthraquinonyl sulfide) (PAQS), a lithium oxocarbon, 3,4,9,10-perylenetetracarboxylic dianhydride (PTCDA), poly(anthraquinonyl sulfide), pyvene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

48. The lithium-ion cell of claim 47, wherein said thioether polymer is selected from Poly[methanetetryl-tetra(thiomethylene)] (PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene](PEDTT).

49. The lithium-ion cell of claim 37, wherein said organic material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

50. The lithium-ion cell of claim 37, wherein said prelithiated anode includes Si that is prelithiated to approximately 60-100% and the cathode includes a cathode active material that is initially lithium-free.
